(19) United States
(12) Patent Application Publication
(10) Pub. No.: US 2010/0162244 A1
(43) Pub. Date: Jun. 24, 2010

(54) COMPUTER WORK CHAIN AND A METHOD FOR PERFORMING A WORK CHAIN IN A COMPUTER

(76) Inventors: Johney Tsai, Irvine, CA (US); David Strong, Laguna, CA (US); Chi Lin, Chino Hills, CA (US)

Correspondence Address: UNISYS CORPORATION, UNISYS WAY, MAIL STATION: E8-114, BLUE BELL, PA, 19424, US

(21) Appl. No.: 12/502,504

(22) Filed: Jul. 14, 2009

Related U.S. Application Data
(63) Continuation-in-part of application No. 12/347,032, filed on Dec. 31, 2008.
Application No. 12/347,032 is a continuation of application No. 12/340,844, filed on Dec. 22, 2008.

(51) Int. Cl. G06F 9/46

(52) U.S. Cl. 718/100

(57) ABSTRACT

A computerized work chain and methods are provided. The work chain comprises at least one processing device configured to perform the computerized work chain M work queues implemented in the one or more processing devices, and a work queue handler implemented in the one or more processing devices, where M is a positive integer that is greater than or equal to one. Each work queue comprises a queue monitor, an exception monitor, a pool of worker threads, a logger, and a data queue. The work queue handler forms the work chain by linking the M work queues together such that respective outputs of a first one of the work queues through an M^{nth}−1 one of the work queues are linked to respective inputs of a second one of the work queues through an M^{nth} one of the work queues, respectively.

### CROSS-REFERENCE TO RELATED APPLICATIONS

This application is a continuation-in-part application of U.S. nonprovisional application Ser. No. 12/347,032, entitled “JAVA ENTERPRISE RESOURCE MANAGEMENT SYSTEM AND METHOD”, filed on Dec. 31, 2008, the benefit of the filing date to which priority is hereby claimed, and which is hereby incorporated by reference herein in its entirety.

### TECHNICAL FIELD

The instant disclosure relates to a computer work chain comprising work queues that are linkable such that a work result produced by one work queue in the work chain is deliverable to a next work queue in the work chain.

### BACKGROUND

Computer work chains are used to perform work functions in a computer processing device, such as a central processing unit (CPU) of a server, for example. Computer work chains are implemented in software running on the computer processing device. The work chain is typically made up of a plurality of work queues, with each work queue being capable of performing one or more work tasks. The work chain executes when a caller makes a call to a method associated with the work chain. Work chains are typically designed to operate asynchronously such that when a call is made to the method, control returns to the caller while the work chain processes the call. When the work chain completes the processing of the call, the work chain notifies the caller that the call has been processed and returns a return value to the caller. Using asynchronous calls in this manner enables the caller, typically referred to as the client, to perform other tasks while the work chain is processing a call, such as making other calls to the same or other methods.

The work queues are typically arranged in a list. Each work queue in the list typically has functionality for receiving a value that is provided as input to the work queue, performing at least one process on the received value, and outputting the processed value to the next work queue in the work chain. The work chain has a pool of worker threads from which the work queues select worker threads to perform the functions of the work queues. When a work queue needs a worker thread, a work chain monitor determines whether a worker thread in the pool is available to be used by the work queue, and if so, allocates the available worker thread to the work queue. Work chains often include additional functionality, such as exception monitoring and logging.

One of the disadvantages associated with the manner in which work chains are currently configured is that there is only a single worker thread pool from which all of the work queues select worker threads. The shared nature of the worker thread pool creates contention between the worker queues. However, work queues that perform short-running jobs are treated the same as those that perform long-running jobs with respect to the allocation of worker threads to the work queues. Consequently, the work queues that perform the longer-running jobs cause a general slowdown of the work chain by starving the other work queues of worker threads.

### SUMMARY

The invention is directed to a computerized work chain and methods for performing a work chain. The work chain comprises at least one processing device, M work queues, where M is a positive integer that is greater than or equal to one, and a work queue handler. Each work queue comprises a queue monitor, an exception monitor, a pool of worker threads, a logger, and a data queue. The processing device is configured to perform the computerized work chain. The M work queues, QJ through QN, are at positions J=0 through J=N, respectively, in a linked list, where M≧1 and where N=M−1. The work queues are implemented in the processing device. The work queue handler is implemented in the processing device. The work chain has a work chain input and a work chain output. The work queue handler forms the work chain by linking the work queues QJ through QN together such that respective outputs of work queues Q0 through QN−1 are linked to respective inputs of work queues Q1 through QN, respectively. The input of work queue Q0 is linked to the work chain input and an output of work queue QN is linked to the work chain output. Work requests J0 through JN are saved in the data queues of work queues Q0 through QN, respectively. The J1 through JN work requests correspond to J0 through JN−1 work results, respectively, produced by the work queues Q0 through QN−1 processing the J0 through JN work requests, respectively, with respective worker threads of the Q0 through QN−1 work queues, respectively. A JN work result produced by work queue QN processing work request JN is provided at the output of the work chain.

The method comprises the following steps A-F. In step A, a work request at an input to the work chain is received in a work queue handler of the work chain. In step B, the work queue handler selects a work queue at a position, J, in a linked list of M work queues to process the work request and allocates the work request to the J^{th} work queue, where M is a positive integer that is greater than or equal to one and where J is a non-negative integer having a value that ranges from J=0 to J=N, where N=M−1. In step C, the J^{th} work queue receives the work request at its input and attempts to process the work request. If the J^{th} work queue is successful at processing the work request, the work queue outputs a work result at its output. In step D, if the J^{th} work queue was successful at producing the work result, it sends a notification from the J^{th} work queue to the work queue handler to indicate that the J^{th} work result has been successfully produced. In step E, if the notification has been received in the work queue handler, the work queue handler determines whether the value of J is equal to N. If the value of J is not equal to N, the handler increments the value of J from a previous J value to a new J value. After J has been incremented, the method returns to step C with the work result produced at the output of the work queue at the J^{th} position corresponding to the previous J value being provided as a work request at the input of the work queue at the J^{th} position corresponding to the new J value. If it is determined at step E that the notification has been received and that the value of J is equal to N, the handler causes the J^{th} work result to be output from an output of the work chain.

The invention also provides a computer-readable medium having a computer program stored thereon comprising computer instructions for performing a work chain in a processing device. The program comprises first, second, third, and fourth sets of instructions. The first set of computer instructions receives a work request at an input to the work chain. The second set of computer instructions selects a work queue at a position, J, in a linked list of M work queues to process the work request and allocates the work request to the J^{th} work queue, where M is a positive integer that is greater than or equal to one and where J is a non-negative integer having a value that ranges from J=0 to J=N, where N=M−1. Each work queue comprises a respective queue monitor, a respective exception monitor, a respective pool of worker threads, a respective logger, and a respective data queue. The third set of computer instructions performs a J^{th} work queue algorithm that attempts to process the work request in the J^{th} work queue. If the J^{th} work queue algorithm is successful at processing the work request, the J^{th} work queue algorithm outputs a work result from an output of the J^{th} work queue and outputs a call back notification. The notification provides an indication that the J^{th} work result has been successfully produced. The J^{th} work queue algorithm includes a J^{th} work queue monitor, a J^{th} exception monitor, a J^{th} pool of worker threads, a J^{th} logger, and a J^{th} data queue. The fourth set of instructions determines whether the notification has been output by the third set of instructions, and if so, whether the value of J is equal to N. If the value of J is not equal to N, the fourth set of instructions causes the value of J to be incremented from a previous J value to a new J value. After J has been incremented, the third set of instructions uses the work result produced at the output of the work queue at the J^{th} position in the linked list corresponding to the previous J value to be used as a work request at the input of the work queue at the J^{th} position in the linked list corresponding to the new J value. If the fourth set of instructions determines that the notification has been output by the third set of instructions and that the value of J is equal to N, the fourth set of instructions causes the work result output from the J^{th} work queue to be output from an output of the work chain.

These and other features and advantages will become apparent from the following description, drawings and claims.

### BRIEF DESCRIPTION OF THE DRAWINGS

FIG. 1 illustrates a block diagram of the JERM system in accordance with an embodiment.

FIG. 2 illustrates a block diagram of the JERM system in accordance with another illustrative embodiment.

FIG. 3 illustrates a block diagram of a work chain comprising a plurality of work queues and a work queue handler in accordance with an illustrative embodiment.

FIG. 4 illustrates a block diagram that represents the functional components of one of the work queues shown in FIG. 3 in accordance with an illustrative embodiment.

FIG. 5 illustrates a flowchart that represents the method performed by the work chain described above with reference to FIG. 3 in accordance with an illustrative embodiment.

FIG. 6 illustrates a flowchart that represents the method performed by the exemplary work queue shown in FIG. 4 in accordance with an illustrative embodiment.

FIG. 7 illustrates a flowchart that represents a method in accordance with an illustrative embodiment for performing Java enterprise resource management on the client side of the JERM management system shown in FIG. 1.

FIG. 8 illustrates a flowchart that represents a method in accordance with an illustrative embodiment for performing Java enterprise resource management on the server side of the JERM management system shown in FIG. 1.

### DETAILED DESCRIPTION

The invention is directed to a work chain and methods performed by the work chain. The work chain is implemented in a combination of hardware and software. The work chain comprises at least one processing device configured to perform the computerized work chain, M work queues implemented in the one or more processing devices, and a work queue handler implemented in the one or more processing devices, where M is a positive integer that is greater than or equal to one. Each work queue comprises a queue monitor, an exception monitor, a pool of worker threads, a logger, and a data queue. The work queue handler forms the work chain by linking the M work queues together such that respective outputs of a first one of the work queues through an M^{nth}−1 one of the work queues are linked to respective inputs of a second one of the work queues through an M^{nth} one of the work queues, respectively.

To illustrate examples of manners in which the work chain may be employed in a particular technological environment or industry, examples are provided herein of the work chain employed in a Java enterprise resource management (JERM) system. The JERM system combines attributes of run-time RMSs and call-analysis RMSs to allow both timing metrics and call metrics to be monitored in real-time, and which can cause appropriate actions to be taken in real-time. It should be noted, however, that the work chain is not limited with respect to environments or industries in which it is suitably employed, as will be understood by persons of ordinary skill in the art, in view of the description provided herein. Persons of ordinary skill in the art will understand, in view of the description provided herein, that the work chain is suitable for use in many different environments and industries. The description herein of the work chain being employed in a JERM system is provided merely for the purpose of giving a real-world example of one suitable use of the work chain. Prior to providing a detailed description of the work chain and the corresponding methods, a detailed description of the exemplary JERM system will be provided and then a description of the work chain as employed in the JERM system will be provided.

The JERM system with which the work chain may be employed provides a level of granularity with respect to the monitoring of methods that are triggered during a transaction that is equivalent to or better than that which is currently provided in the aforementioned known call-analysis RMSs. In addition, the JERM system also provides information associated with the timing of hops that occur between servers, and between and within applications, during a transaction. Because all of this information is obtained in real-time, the JERM system is able to respond in real-time, or near real-time, to cause resources to be allocated or re-allocated in a way that provides improved efficiency and productivity, and in a manner that enables the enterprise to quickly recover from resource failures. In addition, the JERM system is a scalable solution that can be widely implemented with relative ease and that can be varied with relative ease in order to meet a wide variety of implementation needs.

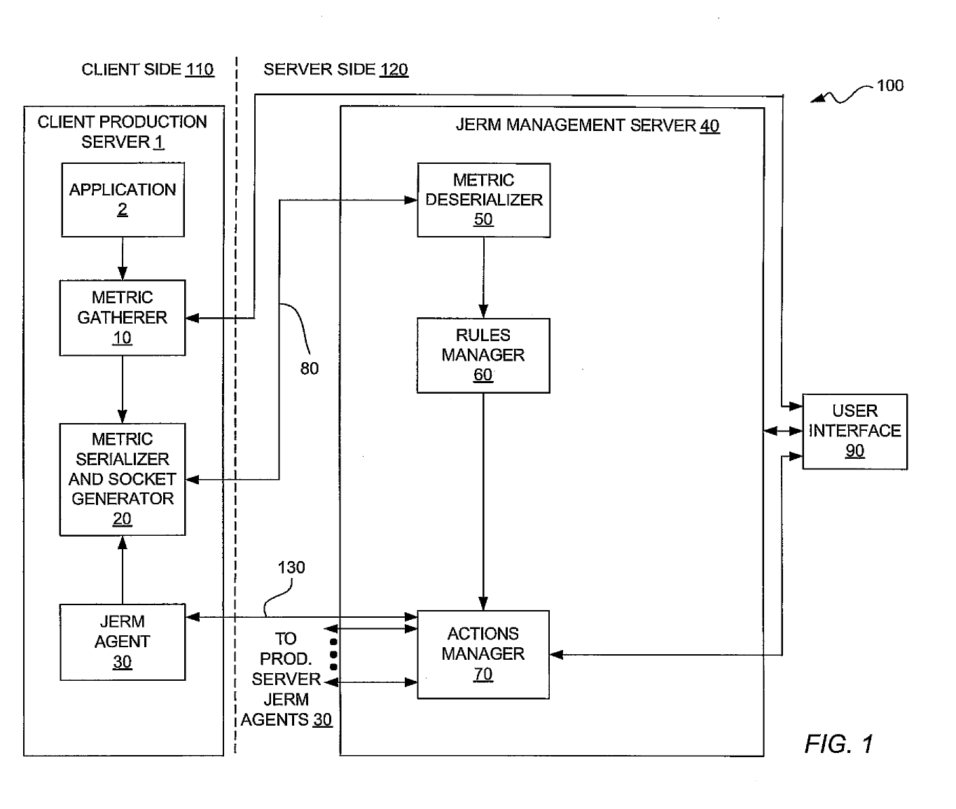

FIG. 1 is a block diagram illustrating an the JERM system 100. The JERM system 100 comprises a client side 110 and a server side 120. On the client side 110, a client Production Server 1 runs various computer software programs, including, but not limited to, an application computer software program 2, a metrics gathering computer software program 10, a metrics serializer and socket generator computer software program 20, and a JERM agent computer software program 30. The Production Server 1 is typically one of many servers located on the client side 110. The Production Server 1 and other servers (not shown) are typically located in a data center (not shown) of the enterprise (not shown). For example, the Production Server 1 may be one of several servers of a server farm, or cluster, that perform similar processing operations, or applications. The application that is performed by each server is controlled by the application computer software program that is being run on the server. In the case of a farm of servers, each server of the same farm may run the same application software program and may have the same operating system (OS) and hardware. A data center may have multiple server farms, with each farm being dedicated to a particular purpose.

The application program 2 that is run by the Production Server 1 may be virtually any Java Enterprise Edition (Java EE) program that performs one or more methods associated with a transaction, or all methods associated with a transaction. During run-time while the application program 2 is being executed, the metrics gathering program 10 monitors the execution of the application program 2 and gathers certain metrics. The metrics that are gathered depend on the manner in which metrics gathering program 10 is configured. A user interface (UI) 90 is capable of accessing the production server 1 to modify the configuration of the metrics gathering program 10 in order to add, modify or remove metrics. Typical system-level metrics that may be gathered include CPU utilization, RAM usage, disk I/O performance, and network I/O performance. Typical application-level metrics that may be gathered include response time metrics, SQL call metrics, and EJB call metrics. It should be noted, however, that the disclosed system and method are not limited with respect to the type or number of metrics that may be gathered by the metrics gathering program 10.

In the illustrated embodiment, metrics that are gathered by the metrics gathering program 10 are provided to the metrics serializer and socket generator (MSSG) software program 20. The MSSG program 20 serializes each metric into a serial byte stream and generates a communications socket that will be used to communicate the serial byte stream to the JERM Management Server 40 located on the server side 120 of the JERM system 100. The serial byte stream is then transmitted over the socket 80 to the JERM Management Server 40. The socket 80 is typically a Transmission Control Protocol/Internet Protocol (“TCP/IP”) socket that provides a bidirectional communications link between an I/O port of the Production Server 1 and an I/O port of the JERM Management Server 40.

In the illustrated embodiment, the JERM Management Server 40 runs various computer software programs, including, but not limited to, a metrics deserializer computer software program 50, a rules manager computer software program 60, and an actions manager computer software program 70. The metrics deserializer program 50 receives the serial byte stream communicated via the socket 80 and performs a deserialization algorithm that deserializes the serial byte stream to produce a deserialized metric. The deserialized metric comprises parallel bits or bytes of data that represent the metric gathered on the client side 110 by the metrics gathering program 10. The deserialized metric is then received by the rules manager program 60. The rules manager program 60 analyzes the deserialized metric and determines whether a rule exists that is to be applied to the deserialized metric. If a determination is made by the rules manager program 60 that such a rule exists, the rules manager program 60 applies the rule to the deserialized metric and makes a decision based on the application of the rule. The rules manager program 60 then sends the decision to the actions manager program 70. The actions manager program 70 analyzes the decision and decides if one or more actions are to be taken. If so, the actions manager program 70 causes one or more actions to be taken by sending a command to the Production Server 1 on the client side 110, or to some other server (not shown) on the client side 110. As stated above, there may be multiple instances of the Production Server 1 on the client side 110, so the action that is taken may be directed at a different server (not shown) on the client side 110.

In accordance with this example, each Production Server 1 on the client side 110 runs the JERM agent software program 30. For ease of illustration, only a single Production Server 1 is shown in FIG. 1. The JERM agent program 30 is configured to detect if a command has been sent from the actions manager program 70 and to take whatever action is identified by the command. The actions include scaling out one or more physical and/or virtual instances and scaling in one or more physical and/or virtual instances. The commands that are sent from the actions manager program 70 to one or more of the JERM agent programs 30 of one or more of the Production Servers 1 are sent over a communications link 130, which may be an Internet socket connection or some other type of communications link.

An example of an action that scales out another physical instance is an action that causes another Production Server 1 to be brought online or to be re-purposed. By way of example, without limitation, in the scenario given above in which the processing loads on the CPUs of the accounts receivable servers are too high, the rules manager program 60 may process the respective CPU load metrics for the respective accounts receivable servers, which correspond to Production Servers 1, and decide that the CPU loads are above a threshold limit defined by the associated rule. The rules manager program 60 will then send this decision to the actions manager program 70. The actions manager program 70 will then send commands to one or more JERM agent programs 30 running of one or more accounts payable servers, which also correspond to Production Servers 1, instructing the JERM agent programs 30 to cause their respective servers to process a portion of the accounts receivable processing loads. The actions manager program 70 also sends commands to one or more JERM agent programs 30 of one or more of the accounts receivable servers instructing those agents 30 to cause their respective accounts receivable servers to offload a portion of their respective accounts receivable processing loads to the accounts payable servers.

An example where the action taken by the actions manager program 70 is the scaling out of one or more virtual instances is as follows. Assuming that the application program 2 running on the Production Server 1 is a particular application program, such as the checkout application program described above, the actions manager program 70 may send a command to the JERM agent program 30 that instructs the JERM agent program 30 to cause the Production Server 1 to invoke another instance of the checkout application program so that there are now two instances of the checkout application program running on the Production Server 1.

In the same way that the actions manager program 70 scales out additional physical and virtual instances, the actions manager program 70 can reduce the number and types of physical and virtual instances that are scaled out at any given time. For example, if the rules manager program 60 determines that the CPU loads on a farm of accounts payable servers are low (i.e., below a threshold limit), indicating that the serves are being under-utilized, the actions manager program 70 may cause the processing loads on one or more of the accounts payable Production Servers 1 of the farm to be offloaded onto one or more of the other accounts payable Production Servers 1 of the farm to enable the Production Servers 1 from which the loads have been offloaded to be turn off or re-purposed. Likewise, the number of virtual instances that are running can be reduced based on decisions that are made by the rules manager program 60. For example, if the Production Server 1 is running multiple Java virtual machines (JVMs), the actions manager 70 may reduce the number of JVMs that are running on the Production Server 1. The specific embodiments described above are intended to be exemplary, and the disclosed system and method should not be interpreted as being limiting to these embodiments or the descriptions thereof.

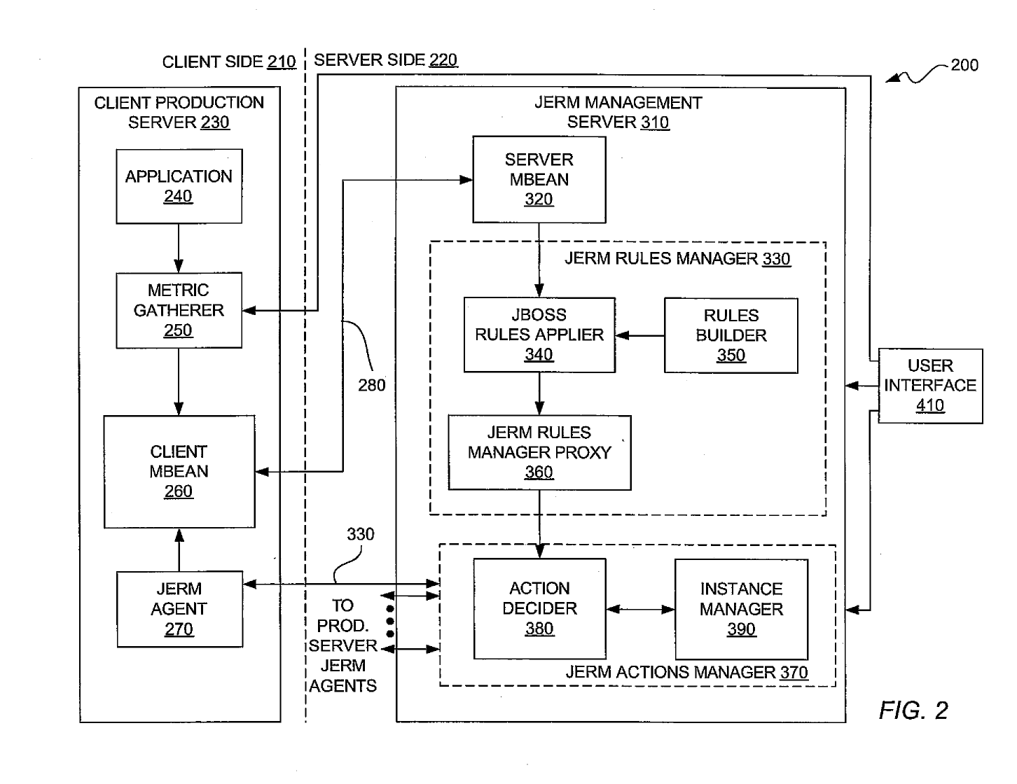

FIG. 2 is a block diagram of the JERM system 200 in accordance with another illustrative embodiment. The JERM system 200 of FIG. 2 includes some of the same components as those of the JERM system 100 shown in FIG. 1, but also includes some additional components and functionality not included in the JERM system 100 of FIG. 1. For example, like the JERM system 100 of FIG. 1, the JERM system 200 of FIG. 2 has a client side 210 and a server side 220, which have a Production Server 230 and a JERM Management Server 310, respectively. On the client side 210, the Production Server 230 runs various computer software programs, including, but not limited to, an application computer software program 240, a metrics gathering computer software program 250, a client Managed Bean (MBean) computer software program 260, and a JERM agent computer software program 270. The Production Server 230 is typically one of many servers located on the client side 210. The Production Server 230 and other servers (not shown) are typically located in a data center (not shown) of the enterprise (not shown). Thus, the JERM Management Server 310 typically communicates with and manages multiple servers, some of which are substantially identical to (e.g., additional instances of) the Production Server 230 running application program 240 and some of which are different from the Production Server 230 and perform functions that are different from those performed by the Production Server 230.

The application program 240 may be any program that performs one or more methods associated with a transaction, or that performs all methods associated with a transaction. During run-time while the application program 240 is being executed, the metrics gathering program 250 monitors the execution of the application program 240 and gathers certain metrics. The metrics that are gathered depend on the manner in which the metrics gathering program 250 is configured. In accordance with this embodiment, the metrics gathering program 250 gathers metrics by aspecting JBoss interceptors. JBoss is an application server program for use with Java EE and EJBs. An EJB is an architecture for creating program components written in the Java programming language that run on the server in a client/server model. An interceptor, as that term is used herein, is a programming construct that is inserted between a method and an invoker of the method, i.e., between the caller and the callee. The metrics gathering program 250 injects, or aspects, JBoss interceptors into the application program 240. The JBoss interceptors are configured such that, when the application program 240 runs at run-time, timing metrics and call metrics are gathered by the interceptors. This feature enables the metrics to be collected in real-time without significantly affecting the performance of the application program 240.

A UI 410, which is typically a graphical UI (GUI) enables a user to interact with the metrics gatherer program 250 to add, modify or remove metrics so that the user can easily change the types of metrics that are being monitored and gathered. Typical system-level metrics that may be gathered include CPU utilization, RAM usage, disk I/O performance, and network I/O performance. Typical application-level metrics that may be gathered include response time metrics, SQL call metrics, and EJB call metrics. It should be noted, however, that the disclosed system and method are not limited with respect to the type or number of metrics that may be gathered by the metrics gathering program 250.

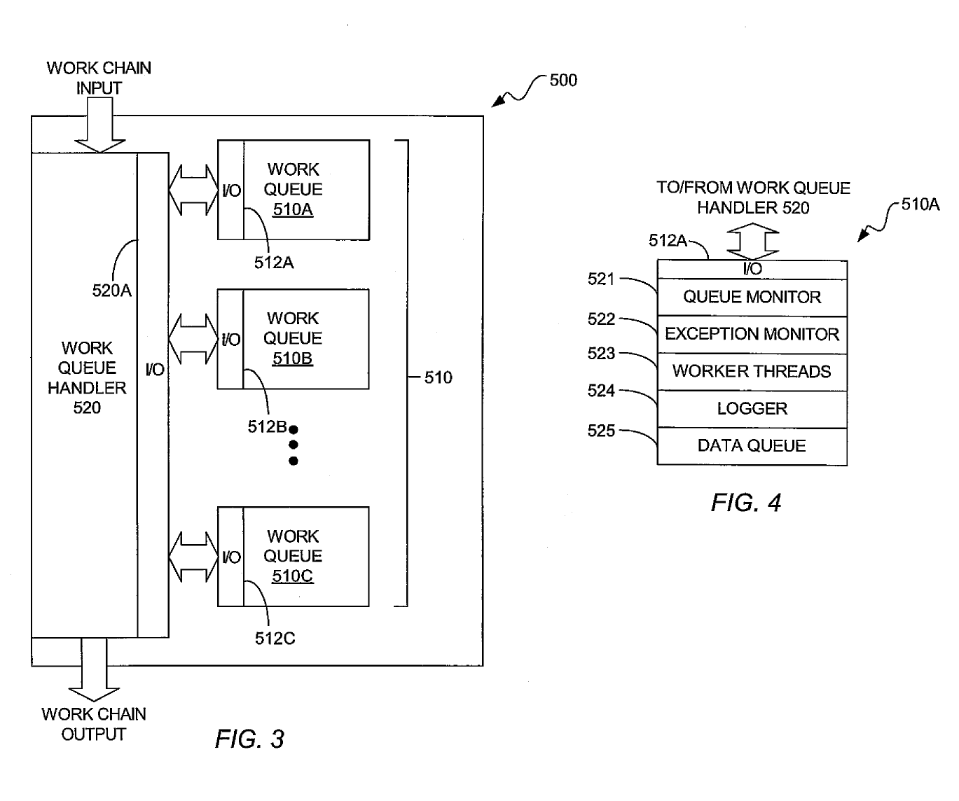

The client MBean program 260 receives the metrics gathered by the JBoss interceptors of the metrics gathering program 250 and performs a serialization algorithm that converts the metrics into a serial byte stream. An MBean is an object in the Java programming language that is used to manage applications, services or devices, depending on the class of the MBean that is used. The client MBean program 260 also sets up an Internet socket 280 for the purpose of communicating the serial byte stream from the client side 210 to the server side 220. The metrics are typically sent from the client side 210 to the server side 220 at the end of a transaction that is performed by the application program 240. As will be described below with reference to FIGS. 3 and 4, in accordance with an embodiment, the MBean program 260 wraps a client-side work chain comprising computer software code that performs the serialization and socket generation algorithms.

The server side 220 includes a JERM Management Server 310, which is configured to run a server MBean computer software program 320, a JERM rules manager computer software program 330, and a JERM actions manager computer software program 370. The server MBean program 320 communicates with the client MBean program 260 via the socket 280 to receive the serial byte stream. The server MBean program 320 performs a deserialization algorithm that deserializes the serial byte stream to convert the byte stream into parallel bits or bytes of data representing the metrics. The JERM rules manager program 330 analyzes the deserialized metric and determines whether a rule exists that is to be applied to the deserialized metric. If a determination is made by the rules manager program 330 that such a rule exists, the rules manager program 330 applies the rule to the deserialized metric and makes a decision based on the application of the rule. The rules manager program 330 then sends the decision to a JERM rules manager proxy computer software program 360, which formats the decision into a web service request and sends the web service request to the JERM actions manager program 370. As will be described below in detail with reference to FIGS. 3 and 4, the deserialization algorithm performed by the server MBean program 320 and the JERM rules manager program 330 are preferably implemented as a server-side work chain.

The JERM actions manager program 370 is typically implemented as a web service that is requested by the JERM rules manager proxy program 360. The JERM actions manager program 370 includes an action decider computer program 380 and an instance manager program 390. The actions decider program 380 analyzes the request and decides if one or more actions are to be taken. If so, the actions decider program 380 sends instructions to the instance manager program 390 indicating one or more actions that need to be taken. In some embodiments, the instance manager program 390 has knowledge of all of the physical and virtual instances that are currently running on the client side 210, and therefore can make the ultimate decision on the type and number of physical and/or virtual instances that are to be scaled out and/or scaled in on the client side 210. Based on the decision that is made by the instance manager program 390, the JERM actions manager program sends instructions via one or more of the communications links 330 to one or more corresponding JERM agent programs 270 of one or more of the Production Servers 230 on the client side 210.

Each Production Server 230 on the client side 210 runs a JERM agent program 270. For ease of illustration, only a single Production Server 230 is shown in FIG. 2. The JERM agent program 270 is configured to detect if a command has been sent from the actions manager 370 and to take whatever action is identified by the command. The actions include scaling out another physical and/or virtual instance and scaling in one or more physical and/or virtual instances. The communications link 330 may be a TCP/IP socket connection or other type of communications link. The types of actions that may be taken include, without limitation, those actions described above with reference to FIG. 1.

The UI 410 also connects to the JERM rules manager program 330 and to the JERM actions manager program 370. In accordance with this embodiment, the JERM rules manager program 330 is actually a combination of multiple programs that operate in conjunction with one another to perform various tasks. One of these programs is a rules builder program 350. A user interacts via the UI 410 with the rules builder program 350 to cause rules to be added, modified or removed from a rules database, which is typically part of the rules builder program 350, but may be external to the rules builder program 350. This feature allows a user to easily modify the rules that are applied by the JBoss rules applier program 340.

The connection between the UI 410 and the JERM actions manager program 370 enables a user to add, modify or remove the types of actions that the JERM actions manager 370 will cause to be taken. This feature facilitates the scalability of the JERM system 200. Over time, changes will typically be made to the client side 210. For example, additional resources (e.g., servers, application programs and/or devices) may be added to the client side 210 as the enterprise grows. Also, new resources may be substituted for older resources, for example, as resources wear out or better performing resources become available. Through interaction between the UI 410 and the JERM actions manager program 370, changes can be made to the instance manager program 390 to reflect changes that are made to the client side 210. By way of example, without limitation, the instance manager program 390 typically will maintain one or more lists of (1) the total resources by type, network address and purpose that are employed on the client side 210, (2) the types, purposes and addresses of resources that are available at any given time, and (3) the types, purposes and addresses of resources that are in use at any given time. As resource changes are made on the client side 210, a user can update the lists maintained by the instance manager program 390 to reflect these changes.

While the work chain and the associated methods are not limited to being used in a JERM system, it is worth mentioning some of the important features that enable the JERM system 200 to provide improved performance over known RMSs of the above-described type. These features include: (1) the use of interceptors by the metrics gatherer program 250 to gather metrics without affecting the performance of a transaction while it is being performed by the application program 240: (2) the use of the client MBean program 260 and client-side work chain to convert the metrics into serial byte streams and send the serial byte stream over a TCP/IP socket 280 to the server side 220; and (3) the use of the server MBean program 320 and the server-side work chain to deserialize the byte stream received over the socket 280 and to apply applicable rules to the deserialized byte stream to produce a decision. These features enable the JERM rules manager program 330 to quickly apply rules to the metrics as they are gathered in real-time and enable the JERM actions manager 370 to take actions in real-time, or near real-time, to allocate and/or re-purpose resources on the client side 210.

The metrics gatherer program 250 can be easily modified by a user, e.g., via the UI 410. Such modifications enable the user to update and/or change the types of metrics that are being monitored by the metrics gatherer program 250. This feature provides great flexibility with respect to the manner in which resources are monitored, which, in turn, provides great flexibility in deciding actions that need to be taken to improve performance on the client side 210 and taking those actions.

Certain functionality on the client side 210 and on the server side 220 is implemented with a client-side work chain and with a server-side work chain, respectively. For example, in one embodiment, the client-side work chain comprises only the functionality that performs the serialization and socket generation programs that are wrapped in the client MBean 260. In one embodiment, the server-side work chain comprises the functionality for performing the socket communication and deserialization algorithms wrapped in the server MBean 320, and the functionality for performing the algorithms of the rules manager program 330. These work chains operate like assembly lines, and parts of the work chains can be removed or altered to change the behavior of the JERM system 200 without affecting the behavior of the application program 240. The work chains are typically configured in XML, and therefore, changes can be made to the work chains in XML, which is an easier task than modifying programs written in other types of languages which are tightly coupled. It should be noted, however, that it is not necessary that the work chains be implemented in any particular programming language. XML is merely an example of a suitable programming language for implementing the work chains. Prior to describing illustrative examples of the manners in which these work chains may be implemented on the client side 210 and server side 220, the general nature of the work chain will be described with reference to FIG. 3.

FIG. 3 illustrates a block diagram of a work chain 500 that demonstrates its functional components and the interaction between those components in accordance with an illustrative or exemplary embodiment. The work chain 500 typically comprises XML code configured for execution by a processing device, such as a microprocessor, for example. Each of the functional components of the work chain 500 performs one or more particular functions in the work chain 500. The work chain 500 is made up of M work queues 510 that can be logically arranged into a pipe configuration, where M is a positive integer that is greater than or equal to one, and a work queue handler 520. For ease of illustration, the work chain 500 is shown in FIG. 3 as having three work queues 510A, 510B and 510C, i.e., M is equal to three in this example. However, it will be understood by persons of ordinary skill in the art, in view of the description being provided herein, that the work chain 500 may comprise virtually any number of work queues 510. The work queue handler 520 interacts with each of the work queues 510, as will be described below in more detail.

The work chain 500 implemented on the server side 220 may have the same number of work queues 510 as the work chain 500 implemented on the client side 210, in which case the number of work queues 510 in both the client-side and server-side work chains is equal to M. However, the number of work queues 510 in the client-side work chain will typically be different from the number of work queues in the server-side work chain. Therefore, the number of work queues in the server-side work chain will be designated herein as being equal to or greater than L, where L is a positive integer that is greater than or equal to one, and where L may be, but need not be, equal to M. Also, it should also be noted that the client side 210 may include a work chain in cases in which the server side 220 does not include a work chain, and vice versa.

Each of the work queues 510A, 510B and 510C has an input/output (I/O) interface 512A, 512B and 512C, respectively. The I/O interfaces 512A-512C communicate with an I/O interface 520A of the work queue handler 520. The work queue handler 520 receives requests to be processed by the work chain 500 from a request originator (not shown) that is external to the work chain 500. The external originator of these requests will vary depending on the scenario in which the work chain 500 is implemented. For example, in the case where the work chain 500 is implemented on the client side 210 shown in FIG. 2, the originator of the requests is typically the client MBean 260, which wraps the serializer and socket generator that comprise the work chain 500.

The work queue handler 520 comprises, or has access to, a linked list of all of the work queues 510A-510C that can be linked into a work chain 500. When a work request from an external originator is sent to the work chain 500, the request is received by the work queue handler 520. The handler 520 then selects the first work queue 510 in the linked list and assigns the request to the selected work queue 510. For example, assuming the position of the work queues 510 in the linked list is represented by the variable J, where J is a non-negative integer having a value that ranges from J=0 to J=N, where N=M−1, the first work queue 510 would be at position J=0 in the list, the second work queue 510 would be work at position J=M−N in the list, the last work queue 510 would be at position J=N in the list, and the second to the last work queue would be at position J=N−1 in the list. The work queue 510 at a given position in the work chain 500 will be referred to hereinafter as “Q_{J}”, where the subscript “J” represents the position of Q in the work chain 500. Therefore, in the illustrative embodiment of FIG. 3 in which the value of N is 2, work queue 510A corresponds to Q_{0 (J=0)} in the list, work queue 510B corresponds to Q_{1 (J=1=M-N)} in the list, and work queue 510C corresponds to Q_{2 (J=2=M-N+1)} in the list. Thus, a linked list of work queues 510 is logically arranged in the following order from the first work queue 510 to the last work queue 510 in the list: Q_{J=0}, Q_{J=M-N}, Q_{J=M-N+1} . . . Q_{J=N=M-N}, provided J is always greater than or equal to 1. For a given value of J other than J=0 or J=N, the output of Q_{J-1} is the input of Q_{J} and the output of Q_{J} is the input of Q_{J+1}. For J=0, Q_{J} is the first work queue 510 in the work chain 500, so its input is the input request received by the work chain 500 and its output is the input of Q₁. For J=N, Q_{J=N} is the last work queue 510 in the work chain 500, so its input is the output of Q_{J=N-1} and its output is the output of the work chain 100.

Therefore, the request received by the handler 520 from the external request originator is assigned by the handler 510 to the work queue Q0 in the list, which is work queue 510A in the illustrative embodiment of FIG. 3. Assuming work queue Q0 in the list successfully processes the request to produce a work result, the handler 520 causes the work result to be assigned to work queue Q1. Whenever one of the work queues 510 successfully completes the processing of a request, the work queue 510 sends a call back to the handler 520. When the handler 520 receives the call back, the handler 520 assigns the work result produced by the successful work queue 510 to the next work queue 510 in the work chain 500. For example, if a work queue Q₄ (position J=M−N+3) in the list successfully processes a request, the handler 520 will cause the result produced by the work queue Q₄ to be assigned to a work queue Q₅ (position J=M−N+4) in the list. This process continues until the work result produced by work queue Q_{N-1} (position J=N−1) has been passed by the handler 520 to the work queue Q_{N} (position J=N in the list), and the final work queue Q_{N} has processed the work unit and produced a final result. The handler 520 then causes that final result to be output from the work chain 500.

In order for the work queue handler 520 to assign a request to a work queue 510, the handler 520 makes a synchronous call to the selected work queue 510. The result of the synchronous call is a success if the handler 520 is able to successfully assign this request to the selected work queue 510 before a timeout failure occurs. The result of the synchronous call is unsuccessful if the handler 520 is not able to successfully assign the request to the selected work queue 510 before a timeout failure occurs.

For example, it will be assumed that the handler 520 successfully assigned a request to work queue 510A and that work queue 510A successfully processed the request and sent a call back to the handler 520. Assuming the work queue 510B is the next work queue in the list, the handler 520 selects the work queue 510B to receive the result produced by work queue 510A. Thus, in this example, the output of the work queue 510A is used as the input of the work queue 510B. Once the result has been produced by work queue 510A, the handler 520 will attempt to synchronously add the result to the work queue 510B using the aforementioned synchronous call. If the synchronous call fails, the handler 520 will assume that work queue 510B did not successfully process the request. This process continues until the work chain 500 has produced its final result. The handler 520 then causes the final result to be output at the work chain output.

FIG. 4 illustrates a block diagram that represents the functional components of one of the work queues 510 shown in FIG. 3 in accordance with an illustrative embodiment. The work queues 510 preferably have identical configurations. Therefore, the functional components of only one of the work queues, work queue 510A, are shown in FIG. 4. The work queue 510A includes the I/O interface 512A, a queue monitor 521, an exception monitor 522, one or more worker threads 523, a logger 524, and a data queue 525. The data queue 525 is a data structure that stores an incoming request received at the I/O interface 512A of the work queue 510A. The queue monitor 521 is a programming thread that monitors the data queue 525 to determine if a request is stored therein, and if so, to determine if a worker thread 523 is available to handle the request. The queue monitor 521 maintains a list of available worker threads 523 in the work queue 510A. In essence, the list maintained by the queue monitor 521 constitutes a pool of available worker threads 523 for the corresponding work queue 510A. The worker threads 523 are programming threads configured to perform the tasks of processing the requests and producing a work result for the corresponding work queue 510.

If the queue monitor 521 determines that a request is stored in the data queue 525 and that a worker thread from the worker thread pool 523 is available to process the request, the queue monitor 521 reads the request from the data queue 525 and assigns the request to an available worker thread. The available worker thread is then removed from the pool of available worker threads 523 and begins processing the request. If the worker thread that is assigned the request successfully completes the processing of the request, the worker thread sends the aforementioned call back to the handler 520 to inform the handler 520 that it has successfully processed the request. The handler 520 then causes the result produced by the worker thread to be handed off, i.e., assigned, to the next work queue 510 in the work chain 500.

It should be noted that in contrast to the known work chain described above, in the work chain 500, each work queue 510 has its own pool of worker threads 523. The number of worker threads that are in the worker thread pool 523 is selected based on the type of tasks or tasks that are to be performed by the work queue 510. Therefore, work queues 510 that are expected to be longer-running work queues 510 can be defined to have larger pools of worker threads 523 than those which are expected to be shorter-running work queues 510. This feature prevents longer-running work queues 510 from slowing down the work chain 500. This feature also reduces contention between worker threads trying to obtain work. In addition, the number of worker threads that are in a pool of worker threads 523 for a given work queue 510 can be easily modified by modifying the code associated with that particular work queue 510 to increase or decrease the number of worker threads that are in its worker thread pool 523. This feature eliminates the need to modify the entire work chain in order to modify a particular work queue 510.

The exception monitor 522 is a programming thread that monitors the worker threads 523 to determine whether or not an uncaught exception occurred while the worker thread 523 was processing the request that caused the worker thread 523 to fail before it finished processing the request. If a worker thread 523 is processing a request when an exception occurs, and the exception is not caught by the worker thread 523 itself, the exception monitor 522 returns the failed worker thread 523 to the pool of available worker threads 523 for the given work queue 510. The exception monitor 522 is useful in this regard because without it, if an exception occurs that is not caught by the worker thread 523, the Java Virtual Machine (JVM) (not shown) will detect that the uncaught exception has occurred and will then terminate the failed worker thread 523, making it unavailable to process future requests. In essence, the exception monitor 522 detects the occurrence of an uncaught exception and returns the failed worker thread 523 to the worker thread pool before the JVM has an opportunity to terminate the failed worker thread 523. Returning failed worker threads 523 to the worker thread pool rather than allowing them to be terminated by the JVM increases the number of worker threads 523 that are available at any given time for processing incoming requests to the work chain 500.

The logger 524 is a programming thread that logs certain information relating to the request, such as, for example, whether an exception occurred during the processing of a request that resulted in a worker thread 523 failing before it was able to complete the processing of the request, the type of exception that occurred, the location in the code at which the exception occurred, and the state of the process at the instant in time when the exception occurred.

In addition to the functionality of the work queue 510A described above, each of the work queues 510 in the work chain 500 is capable of being stopped by the handler 520. In order to stop a particular one of the work queues 510, the request originator sends a poison command to the work chain 500. The handler 520 receives the poison command and causes an appropriate poison command to be sent to each of the work queues 510. When a work queue 510 receives a poison command from the handler 520, the work queue 510 sends a corresponding poison request to its own data queue 525 that causes all of the worker threads 523 of that work queue 510 to shutdown. The work queues 510 are GenericWorkQueue base types, but each work queue 510 may have worker threads 523 that perform functions that are different from the functions performed by the worker threads 523 of the other work queues 510. For example, all of the worker threads 523 of work queue 510A may be configured to perform a particular process, e.g., Process A, while all of the worker threads 523 of work queue 510B may be configured to perform another particular process, e.g., Process B, which is different from Process A. Thus, the poison command that is needed to stop work queue 510A will typically be different from the poison command that is needed to stop work queue 510B. Rather than requiring the external request originator to send different poison requests to each of the work queues 510 in the work chain 500, the external request originator may send a single poison request to the handler 520, which will then cause each of the queue monitors 521 to send an appropriate poison command to its respective data queue 525 that will cause the respective worker threads 523 of the respective worker queue 510 to shutdown.

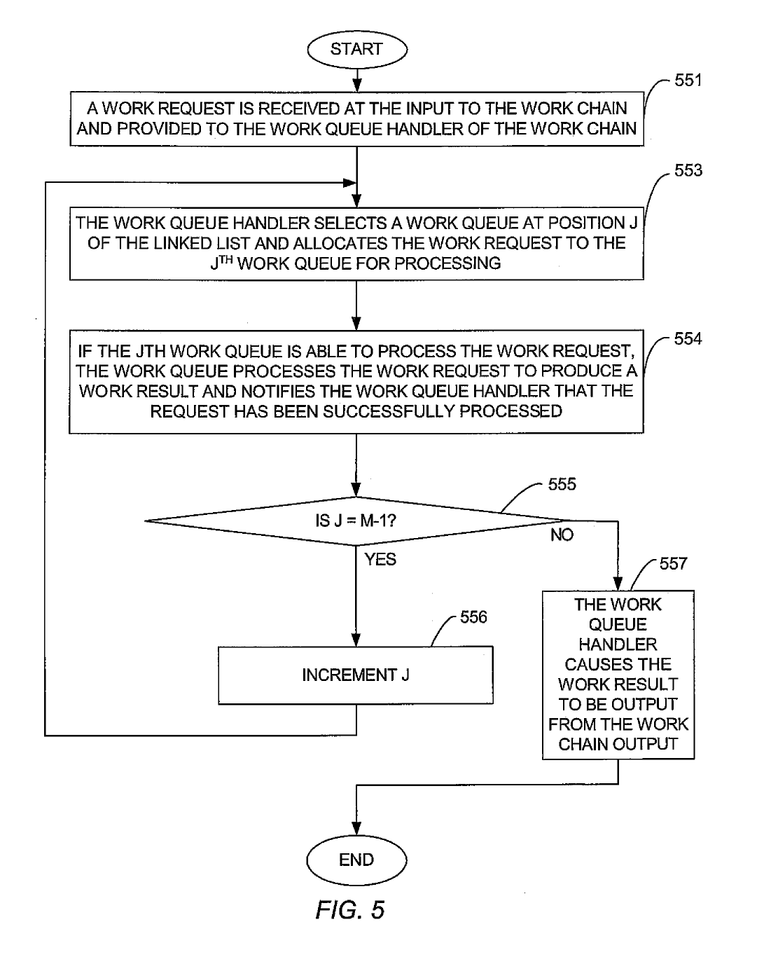

FIG. 5 illustrates a flowchart that represents the method performed by the work chain described above with reference to FIG. 3 in accordance with an illustrative embodiment. The method will be described with reference to FIGS. 3 and 5. A work request is received at an input to the work chain 500 and provided to the work queue handler 520, as indicated by block 551. The work queue handler 520 selects a J^{th} work queue 510 from a linked list of M work queues to process the work request and assigns the work request to the selected work queue 510, as indicated by block 553. As indicated above, M is a positive integer and J is a non-negative integer ranging in value from J=0 to J=N, where N=M−1. The initial values of M and J are set (not shown) prior to initial values. Thus, on the first pass through the algorithm, the J^{th} position corresponds to the first position, position 0, in the linked list. Assuming the selected work queue 510 successfully processes the assigned work request, the selected work queue 510 produces a work result and notifies the work queue handler 520 that the work request has been successfully processed, as indicated by block 554. The work queue handler 520 determines whether or not the value of J has reached its maximum value of N, as indicated by block 555. If not, the value of J is incremented at block 556 and the process returns to block 553. If so, this means that no further processing by the work chain is needed, and the work queue handler 520 causes the work result to be output from the work chain 500 at the work chain output, as indicated by block 557. Thus, the process iterates until a determination is made at block 555 that J=N, i.e., that no further processing by the work chain 500 is needed.

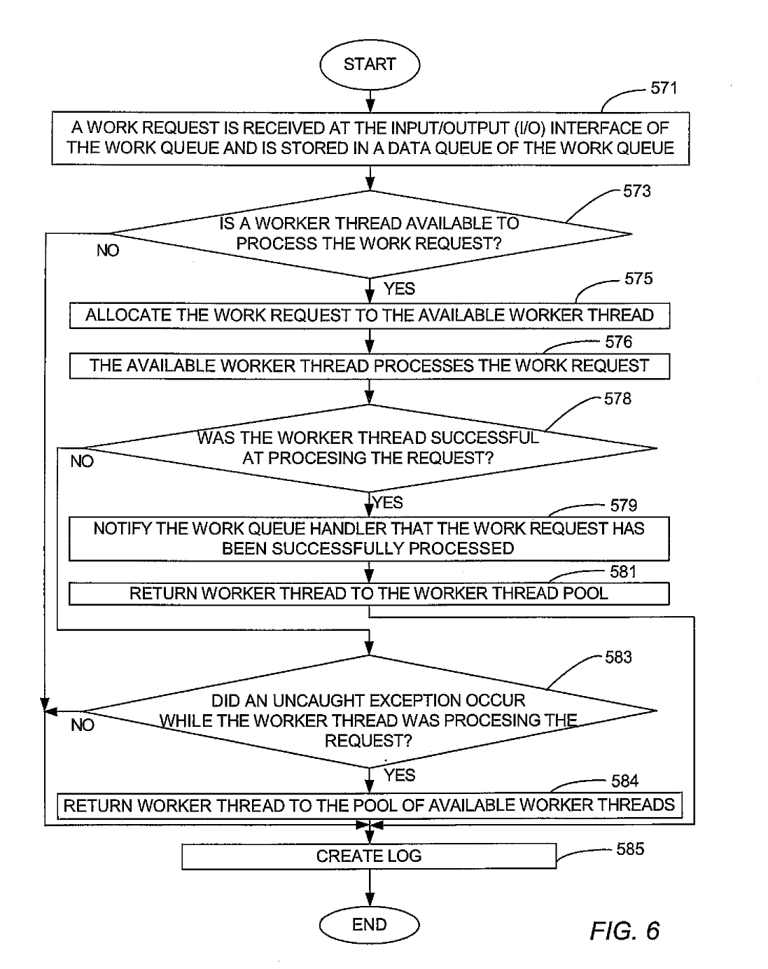

FIG. 6 illustrates a flowchart that represents the method performed by the exemplary work queue 510A shown in FIG. 4 in accordance with an illustrative embodiment. The method will be described with reference to FIGS. 3, 4 and 6. A work request that has been assigned to the work queue 510A is received at the I/O interface 521A of the work queue 510A and stored in the data queue 525 of the work queue 510, as indicated by block 571. The queue monitor 521 of the work queue 510A then determines whether or not a worker thread of the pool of worker threads 523 is available to process the work request, as indicated by block 573. If a determination is made at block 573 that a worker thread is available to process the work request, the queue monitor 521 allocates the request to the available worker thread, as indicated by block 575. The worker thread then attempts to process the work request and produces a work result, as indicated by block 576. When the worker thread stops processing the work request, a determination is made by the queue monitor 510A as to whether or not the worker thread was able to successfully process the work request, as indicated by block 578. If so, the queue monitor 521 causes a notification to be sent over the I/O interface 512A of the work queue 510 to the work queue handler 500, as indicated by block 579. The worker thread is then returned to the pool of available worker threads, as indicated by block 581. The process then proceeds to block 585. If a determination is made at block 573 that a worker thread is not available to process the work request, the process also proceeds to block 585.

If it is determined at block 578 that the worker thread was unsuccessful at processing the request, the process proceeds to block 583. At block 583, the exception monitor 522 determines whether an exception occurred during the process of the request by the worker thread that was not caught by the worker thread. If so, the exception monitor 522 returns the worker thread to the pool of available worker threads 523, as indicated by block 584. The logger 524 of the work queue 510A logs the aforementioned information relating to the processing of the work request by the work queue 510A, such as, for example, whether an exception occurred during the processing of the request, and if so, the type of exception that occurred, as indicated by block 585.

As indicated above, the work chain is typically, but not necessarily, implemented in XML code. With reference again to the exemplary implementation of the work chain in a JERM system, the following XML code corresponds to the client-side work chain configuration file in accordance with the embodiment referred to above in which the client-side work chain only includes the functionality corresponding to the serialization and socket generation programs that are wrapped in the client MBean 260 shown in FIG. 2.

<?xml version=“1.0” encoding=“UTF-8” ?>
<production>

<!-- unique name to identify this production server -->
<identification>

<name>Prod1</name>

</identification>
<!-- information describing where the JERM Management server is -->
<bindings>

<serverAddress>localhost</serverAddress>
<serverPort>9090</serverPort>

</bindings>
<!-- min/max number of threads to perform network io -->
<workers>

<min>10</min>
<max>20</max>

</workers>
<!-- min/max number of connections in the connection pool-->
<connections>
<min>32</min>

<max>64</max>
<refill>16</refill>

</connections>
<!--

name = class to instantiate
minThreads = minimum number of worker threads to service work queue
maxThreads = maximum number of worker threads to service work queue
addTimeout = maximum time in ms to wait before timing out trying to

produce to the work queue

-->

<work chain>

<work queue>

<name>com.unisys.jerm.queue.client.SerializerQueue</name>
<minThreads>16</minThreads>
<maxThreads>32</maxThreads>
<addTimeout>200</addTimeout>

</work queue>

</production>

The client-side work chain can be easily modified to include an audit algorithm work queue that logs information to a remote log identifying any processes that have interacted with the data being processed through the client-side work chain. Such a modification may be made by adding the following audit <work queue> to the XML code listed above:

<work queue>

<name>com.unisys.jerm.queue.client.MySpecialAuditQueue</name>
<minThreads>16</minThreads>
<maxThreads>32</maxThreads>
<addTimeout>200</addTimeout>

</work queue>

</work chain>

Consequently, in accordance with this example, the XML code for the entire client-side work chain configuration file may look as follows:

<?xml version=“1.0” encoding=“UTF-8” ?>
<production>

<!-- unique name to identify this production server -->
<identification>

<name>Prod1</name>

</identification>
<!-- information describing where the JERM Management server is -->
<bindings>

<serverAddress>localhost</serverAddress>
<serverPort>9090</serverPort>

</bindings>
<!-- min/max number of threads to perform network io -->
<worker threads>

<min>10</min>
<max>20</max>

</worker threads>
<!-- min/max number of connections in the connection pool-->
<connections>
<min>32</min>

<max>64</max>
<refill>16</refill>

</connections>
<!--

name = class to instantiate
minThreads = minimum number of worker threads to service work queue
maxThreads = maximum number of worker threads to service work queue
addTimeout = maximum time in ms to wait before timing out trying to

produce to the work queue

-->

<work chain>

<work queue>

<name>com.unisys.jerm.queue.client.SerializerQueue</name>
<minThreads>16</minThreads>
<maxThreads>32</maxThreads>
<addTimeout>200</addTimeout>

</work queue>
<work queue>

<name>com.unisys.jerm.queue.client.MySpecialAuditQueue</name>
<minThreads>16</minThreads>
<maxThreads>32</maxThreads>
<addTimeout>200</addTimeout>

</work queue>

</work chain>
</production>

With similar ease to that with which the client-side work chain can be modified, the rules builder program 350 shown in FIG. 2 can also be easily modified by a user by making changes to one or more portions of the server-side work chain comprising the rules builder program 350 by, for example, using the user interface 410. Making the rules builder program 350 easily modifiable makes it easy to modify the JERM rules manager program 330. For example, the entire behavior of the JERM management server 310 can be modified by simply modifying XML code of the server-side work chain. Such ability enhances flexibility, ease of use, and scalability of the JERM management system 200.

For example, an archiver computer software program (not shown) could be added to the JERM management server 310 to perform archiving tasks, i.e., logging of metrics data. To accomplish this, a work queue similar to the audit work queue that was added above to the client-side work chain is added to the server-side work chain at a location in the work chain following the rules manager code represented by block 330 in FIG. 2. As with the audit work queue added above, the archiver work queue will have a namespace, minimum (minThreads) and maximum (MaxThreads) worker thread limits, and a timeout period (addTimeout) limit. The Min and Max thread limits describe how many worker threads are to be allocated to the work queue. The addTimeout limit describes the time period in milliseconds (ms) that the server 310 will wait before it stops trying to add to a full work queue. If for some reason it is later decided that the archiver work queue or another work queue is no longer needed, the work queue can easily be removed by the user via, for example, the user interface 410. For example, if the JERM system 200 is only intended to monitor, gather, and archive metrics data, the work queue of the portion of the server-side work chain corresponding to the JERM rules manager program 330 may be removed. This feature allows the vendor that provides the JERM system 200 to the enterprise customer to add functionality to the JERM system 200 by shipping one or more additional modules that plug into the client-side work chain, the server-side work chain, or both. Furthermore, the addition of such a module or module does not affect any of the core code of the JERM system 200, but allows the customer to design and implement its own custom modules for its specific business needs.

The combination of all of these features makes the JERM system 200 a superior RMS over known RMSs in that the JERM system 200 has improved scalability, improved flexibility, improved response time, improved metrics monitoring granularity, and improved action taking ability over what is possible with known RMSs. As indicated above, the JERM system 200 is capable of monitoring, gathering, and acting upon both timing metrics and call metrics, which, as described above, is generally not possible with existing RMSs. As described above, existing RMSs tend to only monitor, gather, and act upon either timing metrics or call metrics. In addition, existing RMSs that monitor, gather, and act upon call metrics generally do not operate in real-time because doing so would adversely affect the performance of the application program that is performing a given transaction. By contrast, not only is the JERM system 200 capable of monitoring, gathering, and acting upon timing metrics and call metrics, but it is capable of doing so in real-time, or near real-time.

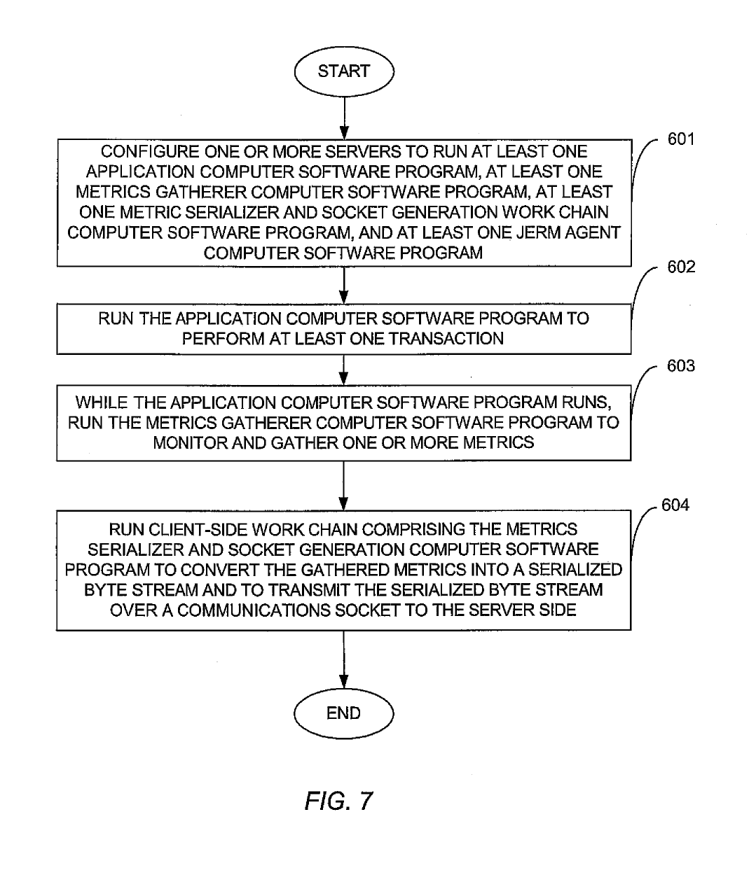

FIG. 7 is a flowchart that illustrates a method in accordance with an illustrative embodiment for performing Java enterprise resource management on the client side. On the client side, a server is configured to run at least one application computer software program, at least one metrics gatherer computer software program, at least one metrics serializer and socket generator computer software program implemented as a work chain 500 (FIG. 3), and at least one JERM agent computer software program, as indicated by block 601. The application program is run to perform at least one transaction, as indicated by block 602. While the application program runs, the metrics gatherer program monitors and gathers one or more metrics relating to the transaction being performed, as indicated by block 603. The client-side work chain 500 comprising the metric serializer and socket generator program converts the gathered metrics into a serial byte stream and transmits the serial byte stream via a socket communications link to the server side, as indicated by block 604.

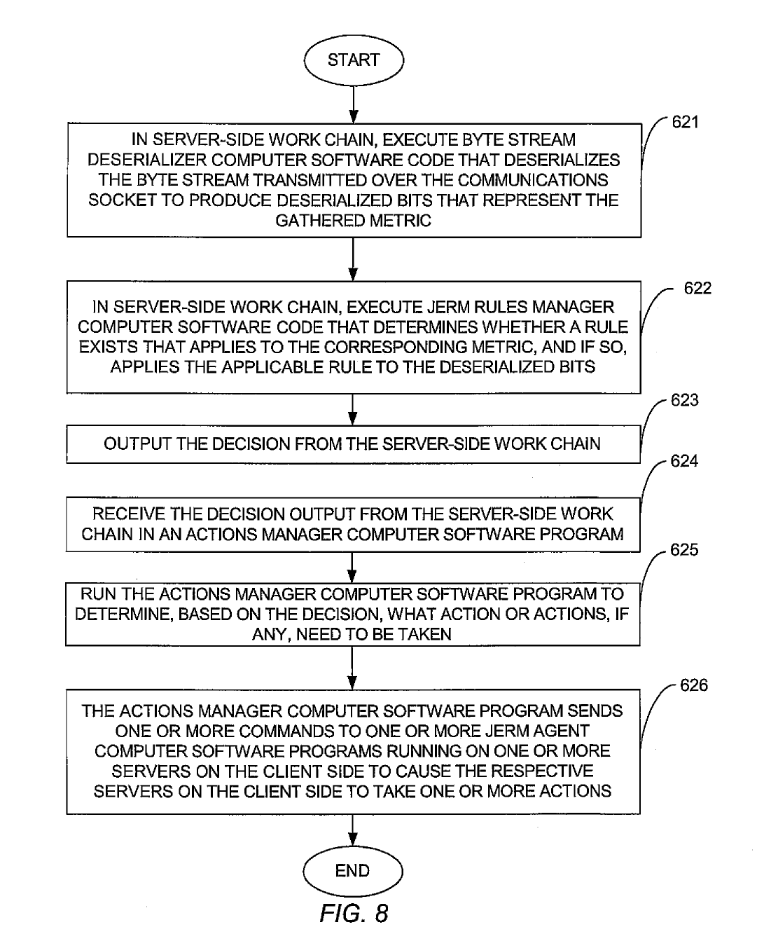

FIG. 8 is a flowchart that illustrates a method in accordance with an illustrative embodiment for performing Java enterprise resource management on the server side. On the server side, the server-side work chain performs byte stream deserialization to produce deserialized bits that represent the gathered metric, as indicated by block 621. The portion of the server-side work chain that performs the JERM rules manager program analyzes the deserialized bits to determine whether a rule exists that applies to the corresponding metric, and if so, applies the applicable rule to the deserialized bits, as indicated by block 622. This decision is then output from the server-side work chain, as indicated by block 623. The decision is then received by an actions manager computer software program, as indicated by block 624. The actions manager program then determines, based on the decision provided to it, one or more actions that are to be taken, if any, as indicated by block 625. The actions manager program then sends one or more commands to one or more JERM agent programs running on one or more servers on the client side instructing the JERM agent programs to cause their respective servers to perform the corresponding action or actions, as indicated by block 626.

As indicated above with reference to FIGS. 1 and 2, the actions may include scaling out one or more physical and/or virtual instances or scaling in one or more physical and/or virtual instances. The actions may also include re-purposing or re-allocation of a physical resource. The disclosed system and method are not limited with respect to the types of physical instances that may be scaled out, scaled in, re-purposed or re-allocated. An example of a physical instance is a server. A virtual instance may include, without limitation, an application computer software program, a JVM, or the like. The disclosed system and method are not limited with respect to the types of virtual instances that may be scaled out or scaled in. Virtual instances generally are not re-purposed or re-allocated, although that does not mean that the JERM system could not re-purpose or re-allocate virtual instances should a need arise to do so.

As described above with reference to FIGS. 3-8, the work chain is typically implemented in XML computer code. Therefore, the algorithms represented by the flowcharts described above with reference to FIGS. 5-8 are typically written in XML code. The computer code for implementing these algorithms is stored on some type of computer-readable medium (CRM). The CRM may be any type of CRM, including, but not limited to, a random access memory (RAM) device, a read-only memory (ROM) device, a programmable ROM (PROM) device, an erasable PROM (EPROM) device, a flash memory device, or other type of memory device. The computer code that implements the work chain is executed in some type of processing device, such as, for example, one or more microprocessors, microcontrollers, special purpose application specific integrated circuit (ASICs), programmable logic arrays (PLAs), programmable gate array (PGAs), or any combination of one or more of such processing devices. When the work chain is employed in environments such as those depicted in FIGS. 1 and 2, the work chain computer code is typically executed by the CPU of the client side and/or server side servers (1, 40, 230, 310).

It should be noted that the disclosed system and method have been described with reference to illustrative embodiments to demonstrate principles and concepts, and features that may be advantageous in some embodiments. The disclosed system and method are not intended to be limited to these embodiments, as will be understood by persons of ordinary skill in the art in view of the description provided herein. For example, the flowchart illustrated in FIG. 5 demonstrates only one of many examples of the manner in which the algorithm for linking the work queues of the work chain together and assigning work requests to the work queues can be performed. Persons of ordinary skill in the art will understand, in view of the description being provided herein the manner in which variations can easily be made to the algorithm while still achieving the objectives described above with reference to FIG. 5. These and a variety of modifications can be made to the embodiments described herein, and all such modifications are within the scope of the instant disclosure, as will be understood by persons of ordinary skill in the art.

What is claimed is:

1. A computerized work chain comprising:
at least one processing device configured to perform the computerized work chain;
M work queues, QJ through QN, at positions J=0 through J=N in a linked list, where M≧1 and where N=M−1, the work queues being implemented in said one or more processing devices, each work queue QJ through QN, comprising:
a queue monitor;
an exception monitor;
a pool of worker threads;
a logger; and
a data queue;
and
a work queue handler implemented in said one or more processing devices, the work chain having a work chain input and a work chain output, wherein the work queue handler forms the work chain by linking the work queues QJ through QN together such that respective outputs of work queues Q0 through QN−1 are linked to respective inputs of work queues Q1 through QN, respectively, and wherein an input of work queue Q0 is linked to the work chain input and wherein an output of work queue QN is linked to the work chain output, and wherein J0 through JN work requests are saved in the data queues of work queues Q0 through QN, respectively, and wherein the J1 through JN work requests correspond to J0 through JN−1 work results, respectively, produced by the work queues Q0 through QN−1 processing the J0 through JN work requests, respectively, with respective worker threads of the Q0 through QN−1 work queues, respectively, and wherein a JN work result produced by work queue QN processing work request JN is provided at the output of the work chain.

2. The work chain of claim 1, wherein the respective queue monitors of the M work queues monitor the respective data queues to determine whether or not respective work request are stored therein, wherein if the respective queue monitors determine that respective work requests are saved in the respective data queues, the respective queue monitors determine whether at least one of the worker threads of the respective pools of worker threads is available to process the work request, and if so, select the available worker threads and allocate the respective work requests to the selected worker threads for processing of the respective work requests by the selected respective worker threads.

3. The work chain of claim 2, wherein if the selected worker threads are successful at processing the allocated respective work requests, the selected worker threads cause respective notifications to be sent to the work queue handler to inform the work queue handler that the allocated work requests have been successfully processed.

4. The work chain claim 3, wherein if the work queue handler receives a notification that one of the allocated work requests have been successfully processed, the work queue handler causes the work result corresponding to the successfully processed work request to be saved in the data queue of the work queue having its input linked to the output of the data queue that produced the work result corresponding to the successfully processed work request.

5. The work chain of claim 4, wherein if the work queue handler does not receive said notification within a timeout period after allocating a respective work request to a respective selected one of the work queues, the work queue handler assumes that the allocated work queue failed.

6. The work chain of claim 5, wherein the respective exception monitors of the respective work queues monitor the selected respective worker threads and determine whether or not an uncaught exception has occurred during the processing of a respective work request by the respective worker thread that caused the respective worker thread to be unsuccessful in processing the respective work request, and wherein the respective loggers of the respective work queues log any occurrence of an exception during the processing of a respective work request by the respective worker thread.

7. The work chain of claim 6, wherein if one of the respective exception monitors determines that the uncaught exception has occurred during the processing of a respective work request by the respective worker thread, the respective exception monitor causes the unsuccessful worker thread to be returned to a pool of available worker threads of the respective work queue.

8. A method for processing work requests in a work chain comprising:
A) in a work queue handler of the work chain, receiving a work request at an input to the work chain;
B) in the work queue handler, selecting a work queue at a position, J, in a linked list of M work queues to process the work request and allocating the work request to the J^{th} work queue, where M is a positive integer that is greater than or equal to one and where J is a non-negative integer having a value that ranges from J=0 to J=N, where N=M−1, and wherein each work queue comprises a respective queue monitor, a respective exception monitor, a respective pool of worker threads, a respective logger, and a respective data queue;
C) in the J^{th} work queue, receiving the work request at an input of the J^{th} work queue and attempting to process the work request, wherein if the J^{th} work queue is successful at processing the work request, the J^{th} work queue outputs a work result from an output of the J^{th} work queue;
D) if the J^{th} work queue was successful at producing the work result, sending a notification from the J^{th} work queue to the work queue handler to indicate that the J^{th} work result has been successfully produced;
E) in the work queue handler, if the notification has been received in the work queue handler, determining whether the value of J is equal to N, and wherein if the value of J is not equal to N, incrementing the value of J from a previous J value to a new J value, and wherein after J has been incremented, the method returns to step C) with the work result produced at the output of the work queue at the J^{th} position in the linked list corresponding to the previous J value being provided as a work request at the input of the work queue at the J^{th} position in the linked list corresponding to the new J value; and
F) if it is determined at step E that the notification has been received and that the value of J is equal to N, causing the J^{th} work result to be output from an output of the work chain.

9. The method of claim 8, wherein if a work request is received at the input of one of the work queues, the received work request is saved in the data queue of the work queue that received the work request, and wherein the queue monitor of the work queue that received the work request monitors the respective data queue and determines whether a work request is saved in the respective data queue, and wherein if the respective queue monitor determines that a work request is saved in the respective data queue, the respective queue monitor determines whether the respective pool of worker threads includes a worker thread that is available to process the saved work request, and wherein if the respective queue monitor determines that a worker thread is available in the respective pool to process the saved work request, the respective queue monitor removes the available worker thread from the respective pool and allocates the received work request to the available worker thread.

10. The method of claim 9, wherein if the worker thread is successful at processing the allocated work request, the worker thread causes said notification to be sent from the work queue to the work queue handler to inform the work queue handler that the allocated work request has been successfully processed.

11. The method of claim 10, wherein the exception monitor of the work queue monitors the worker thread to which the work request has been allocated and determines whether or not an uncaught exception has occurred during the processing of the work request by the worker thread that caused the worker thread to be unsuccessful in processing the respective work request, and wherein the logger of the work queue logs any occurrence of an exception during the processing of the work request by the worker thread.

12. The method of claim 11, wherein if the exception monitor determines that an uncaught exception has occurred during the processing of the work request by the worker thread, the exception monitor causes the unsuccessful worker thread to be returned to the pool of worker threads.

13. A computer-readable medium having a computer program stored thereon comprising computer instructions for processing by a processing device to perform a work chain, the program comprising:
a first set of computer instructions for receiving a work request at an input to the work chain;
a second set of computer instructions for selecting a work queue at a position, J, in a linked list of M work queues to process the work request and allocating the work request to the J^{th} work queue, where M is a positive integer that is greater than or equal to one and where J is a non-negative integer having a value that ranges from J=0 to J=N, where N=M−1, and wherein each work queue comprises a respective queue monitor, a respective exception monitor, a respective pool of worker threads, a respective logger, and a respective data queue;
a third set of computer instructions for performing a J^{th} work queue algorithm that attempts to process the work request in the J^{th} work queue, wherein if the J^{th} work queue algorithm is successful at processing the work request, the J^{th} work queue algorithm outputs a work result from an output of the J^{th} work queue and outputs a call back notification, wherein the notification provides an indication that the J^{th} work result has been successfully produced, wherein the J^{th} work queue algorithm includes a J^{th} work queue monitor, a J^{th} exception monitor, a J^{th} pool of worker threads, a J^{th} logger, and a J^{th} data queue; and
a fourth set of instructions for determining whether the call back notification has been output by the third set of instructions, and if so, whether the value of J is equal to N, and wherein if the value of J is not equal to N, the fourth set of instructions causes the value of J to be incremented from a previous J value to a new J value, and wherein after J has been incremented, the third set of instructions uses the work result produced at the output of the work queue at the J^{th} position in the linked list corresponding to the previous J value to be used as a work request at the input of the work queue at the J^{th} position in the linked list corresponding to the new J value, and wherein if the fourth set of instructions determines that the notification has been output by the third set of instructions and that the value of J is equal to M−1, the fourth set of instructions causes the work result output from the J^{th} work queue to be output from an output of the work chain.

14. The computer-readable medium of claim 13, wherein the received work request is saved in the J^{th} data queue, and wherein the J^{th} queue monitor monitors the J^{th} data queue and determines whether a work request is saved in the J^{th} data queue, and wherein if the J^{th} queue monitor determines that a work request is saved in the J^{th} data queue, the J^{th} queue monitor determines whether the J^{th} pool of worker threads includes a worker thread that is available to process the saved work request, and wherein if the J^{th} queue monitor determines that a worker thread is available in the pool to process the saved work request, the J^{th} queue monitor removes the available worker thread from the pool and allocates the received work request to the available worker thread.

15. The computer-readable medium of claim 14, wherein if the worker thread is successful at processing the allocated work request, the worker thread causes said notification to be sent from the work queue to the work queue handler to inform the work queue handler that the allocated work request has been successfully processed.

16. The computer-readable medium of claim 14, wherein the J^{th} exception monitor of the work queue monitors the worker thread to which the work request has been allocated and determines whether or not an uncaught exception has occurred during the processing of the work request by the worker thread, and wherein the J^{th} logger of the J^{th} work queue logs any occurrence of an exception during the processing of the work request by the worker thread.

17. The method of claim 16, wherein if the J^{th} exception monitor determines that an uncaught exception has occurred during the processing of the work request by the worker thread, the J^{th} exception monitor causes the unsuccessful worker thread to be returned to the pool of worker threads.
